(19) United States
(12) Patent Application Publication
(10) Pub. No.: US 2018/0089786 A1
(43) Pub. Date: Mar. 29, 2018

(54) METHODS AND SYSTEMS FOR CARPOOLING

(71) Applicant: BEIJING DIDI INFINITY TECHNOLOGY AND DEVELOPMENT CO., LTD., Beijing (CN)

(72) Inventors: Kuan SHI, Beijing (CN); Yong YE, Beijing (CN)

(73) Assignee: BEIJING DIDI INFINITY TECHNOLOGY AND DEVELOPMENT C O., LTD., Beijing (CN)

(21) Appl. No.: 15/829,813

(22) Filed: Dec. 1, 2017

Related U.S. Application Data
(63) Continuation of application No. PCT/CN2016/112609, filed on Dec. 28, 2016.

(30) Foreign Application Priority Data
Apr. 1, 2016 (CN) 201610207815.6

(51) Int. Cl. G06Q 50/30; G01C 21/34

(52) U.S. Cl. CPC G06Q 50/30; G01C 21/343

(57) ABSTRACT

The present disclosure relates to systems and methods for carpooling. The systems may perform the methods to obtain a first transaction request associated with a transportation service from a service provider during a first transportation service, wherein the first transportation service includes a first sub transportation service and a second sub transportation service, and the first transaction request of the service provider is transmitted when the service provider completes the first sub transportation service or the second sub transportation service; obtain one or more second transaction requests, wherein the second transaction request is associated with a second transportation service from a service receiver that is not in the first transportation service, and the second transaction request requires the service provider to pick up the service receiver from a first location determined by the service receiver; generate an assignment strategy associated with combining the first transportation service and the second transportation service into a third transportation service; and send the assignment strategy to the service provider.

### CROSS-REFERENCE TO RELATED APPLICATIONS

This application is a continuation of International Application No. PCT/CN2016/112609, filed on Dec. 28, 2016, which claims priority of Chinese Patent Application No. 201610207815.6 filed on Apr. 1, 2016, the contents of which are hereby incorporated by reference to their entirety.

### TECHNICAL FIELD

The present disclosure generally relates to an on-demand service system, and more particularly, to methods and systems for carpooling.

### BACKGROUND

A carpool service refers to an arrangement that combines two or more transportation services into a new transportation service. The carpool service may improve the traffic capacity. However, there are some problems such as inefficiency in existing systems and methods for carpooling. Therefore, it is desirable to provide systems and methods for carpooling to improve the efficiency.

### SUMMARY

According to an aspect of the present disclosure, a system may include one or more storage media and one or more processors configured to communicate with the one or more storage media. The one or more storage media may include a set of instructions for carpooling. When the one or more processors executing the set of instructions, the one or more processors may be directed to perform one or more of the following operations. The one or more processors may obtain a first transaction request associated with a transportation service from a service provider during a first transportation service, wherein the first transportation service may include a first sub transportation service and a second sub transportation service, and the first transaction request of the service provider may be transmitted when the service provider completes the first sub transportation service or the second sub transportation service. The one or more processors may obtain one or more second transaction requests, wherein the second transaction request may be associated with a second transportation service from a service receiver that is not in the first transportation service, and the second transaction request may require the service provider to pick up the service receiver from a first location determined by the service receiver. The one or more processors may generate an assignment strategy associated with combining the first transportation service and the second transportation service into a third transportation service. The one or more processors may send the assignment strategy to the service provider.

In some embodiments, the first transportation service may be associated with a first route, and the second transportation service may be associated with a second route.

In some embodiments, the one or more processors may determine a third route for the third transportation service according to the first transportation service and the second transportation service. The one or more processors may send the third route to the service provider.

In some embodiments, the one or more processors may determine matching information according to the first transaction request and the second transaction requests. The one or more processors may determine one or more candidate transaction requests according to the matching information. The one or more processors may determine a target transaction request according to the candidate transaction requests. The one or more processors may generate the assignment strategy according to the target transaction request.

In some embodiments, the third route may include a first sharing route associated with the first transportation service and a second sharing route associated with the second transportation service.

In some embodiments, the one or more processors may determine a length of the first route, a length of the second route, a length of the first sharing route and a length of the second sharing route. The one or more processors may determine a first ratio of the length of the first sharing route to the length of the first route, and a second ratio of the length of the second sharing route to the length of the second route.

In some embodiments, the one or more processors may obtain a request time of the second transaction request. The one or more processors may determine that the request time is in rush hour. The one or more processors may determine that the assignment strategy is not to combine the first transportation service and the second transportation service into a third transportation service.

In some embodiments, the one or more processors may transmit a confirmation message to the service receiver. The one or more processors may receive a response of refusing to combine the first transportation service and the second transportation service into the third transportation service from the service receiver. The one or more processors may determine that the assignment strategy is not to combine the first transportation service and the second transportation service into a third transportation service.

According to another aspect of the present disclosure, a method may include one or more of the following operations. A computer server of an online on-demand transportation service platform may obtain a first transaction request associated with a transportation service from a service provider during a first transportation service, wherein the first transportation service may include a first sub transportation service and a second sub transportation service, and the first transaction request of the service provider may be transmitted when the service provider completes the first sub transportation service or the second sub transportation service. The computer server may obtain one or more second transaction requests, wherein the second transaction request may be associated with a second transportation service from a service receiver that is not in the first transportation service, and the second transaction request may require the service provider to pick up the service receiver from a first location determined by the service receiver. The computer server may generate an assignment strategy associated with combining the first transportation service and the second transportation service into a third transportation service. The computer server may send the assignment strategy to the service provider.

In some embodiments, the first transportation service may be associated with a first route, and the second transportation service may be associated with a second route.

In some embodiments, the computer server may determine a third route for the third transportation service according to the first transportation service and the second transportation service. The computer server may send the third route to the service provider.

In some embodiments, the computer server may determine matching information according to the first transaction request and the second transaction requests. The computer server may determine one or more candidate transaction requests according to the matching information. The computer server may determine a target transaction request according to the candidate transaction requests. The computer server may generate the assignment strategy according to the target transaction request.

In some embodiments, the third route may include a first sharing route associated with the first transportation service and a second sharing route associated with the second transportation service.

In some embodiments, the computer server may determine a length of the first route, a length of the second route, a length of the first sharing route and a length of the second sharing route. The computer server may determine a first ratio of the length of the first sharing route to the length of the first route, and a second ratio of the length of the second sharing route to the length of the second route.

In some embodiments, the computer server may obtain a request time of the second transaction request. The computer server may determine that the request time is in rush hour. The computer server may determine that the assignment strategy is not to combine the first transportation service and the second transportation service into a third transportation service.

In some embodiments, the computer server may transmit a confirmation message to the service receiver. The computer server may receive a response of refusing to combine the first transportation service and the second transportation service into the third transportation service from the service receiver. The computer server may determine that the assignment strategy is not to combine the first transportation service and the second transportation service into a third transportation service.

### BRIEF DESCRIPTION OF THE DRAWINGS

FIG. 1 is a block diagram of an exemplary on-demand service system 100 according to some embodiments.

FIG. 2 is a schematic diagram illustrating exemplary hardware and software components of a computing device 200 according to some embodiments of the present disclosure.

FIG. 3 is a block diagram illustrating an exemplary architecture of processing engine 112 according to some embodiments of the present disclosure.

FIG. 4 is a flowchart illustrating an exemplary process of a carpool service according to some embodiments of the present disclosure.

FIG. 5 is a block diagram illustrating an exemplary architecture of an assignment strategy generation unit 330 according to some embodiments of the present disclosure.

FIG. 6 is a flowchart illustrating an exemplary process of generating an assignment strategy according to some embodiments of the present disclosure.

FIG. 7 is a flowchart illustrating an exemplary process of generating an assignment strategy according to some embodiments of the present disclosure.

FIG. 8 is a flowchart illustrating an exemplary process of determining one or more candidate transaction requests according to some embodiments of the present disclosure.

FIG. 9 is a flowchart illustrating an exemplary process of generating an assignment strategy according to some embodiments of the present disclosure.

FIG. 10 is a diagram illustrating an exemplary process of a carpool service according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to allocate a set of sharable orders, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to online systems and methods for finding sharable and/or combinable transportation transactions, such as carpooling taxi service. During the carpooling service, a taxi driver may serve two or more passengers together. When the taxi driver reaches or is about to reach the destination of one passenger, the taxi driver may send or accept a carpooling request to further take another passenger.

It should be noted that online on-demand transportation service, such as online carpool service, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). If a driver wants to provider a carpool service, the driver has to ask a passenger face to face and determine whether the carpooling service is possible to be provided to the passenger by experience of the driver. Online carpool service, however, obtains transaction requests and finds combinable transaction requests in real-time and automatically. The carpool service also allows a user of the service to real-time and automatic distribute a service request to a vast number of individual service providers (e.g., taxi) distance away from the user and allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system.

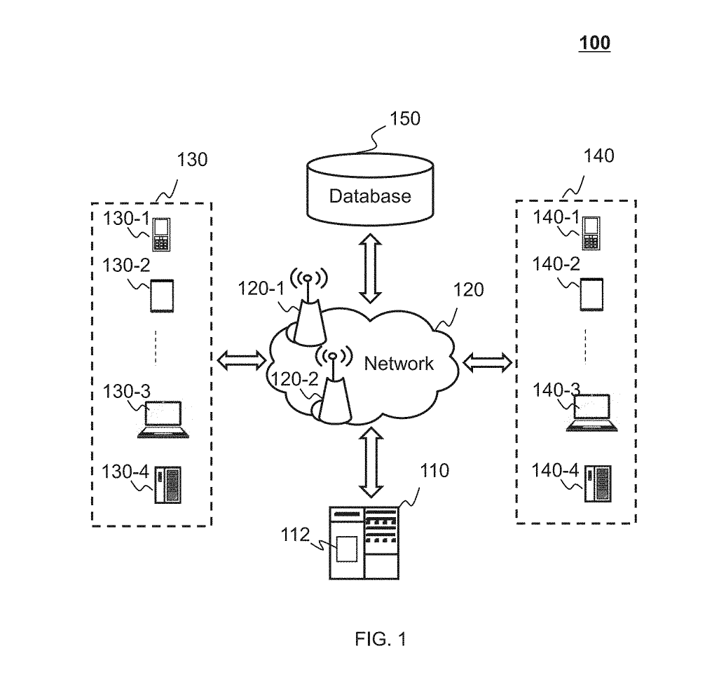

FIG. 1 is a block diagram of an exemplary on-demand service system 100 according to some embodiments. For example, the on-demand service system 100 may be an online transportation service platform for transportation services such as taxi hailing, chauffeur service, express car, carpool, bus service, driver hire and shuttle service. The on-demand service system 100 may be an online platform including a server 110, a network 120, a requester terminal 130, a provider terminal 140, and a database 150. The server 110 may include a processing engine 112.

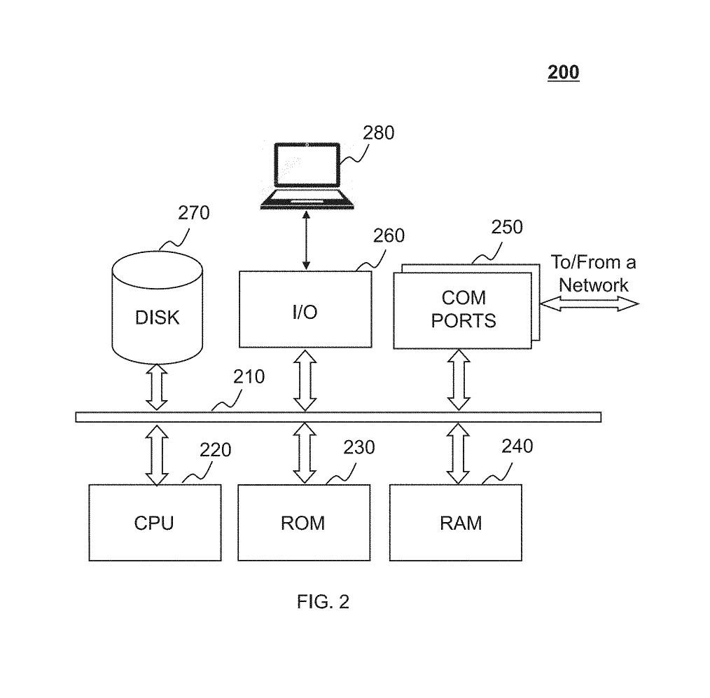

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a target vehicle based on the service request obtained from the requestor terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the requestor terminal 130, the provider terminal 140, and the database 150) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (FDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with other positioning device to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

In some embodiments, one or more components in the on-demand service system 100 (e.g., the server 110, the requestor terminal 130, the provider terminal 140, etc.) may have a permission to access the database 150. In some embodiments, one or more components in the on-demand service system 100 may read and/or modify information relating to the requestor, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be note that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

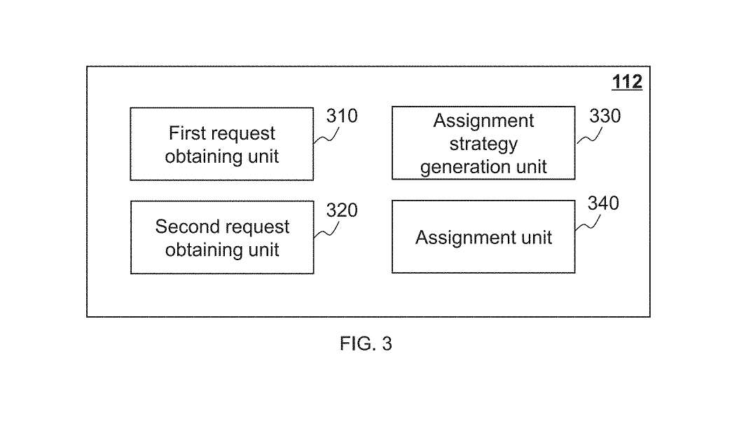

FIG. 3 is a block diagram illustrating an exemplary architecture of a processing engine 112 according to some embodiments of the present disclosure. As illustrated, processing engine 112 may include a first request obtaining unit 310, a second request obtaining unit 320, an assignment strategy generation unit 330 and an assignment unit 340.

In some embodiments, first request obtaining unit 310 may be configured to obtain a transaction request requesting a transportation service from a service provider. In some embodiments, the transportation service may be a service of taking an object from one place to another in a vehicle. The object may include passengers and/or goods. The vehicle may include a non-motor vehicle (e.g., a bicycle or a tricycle), a motor vehicle (e.g., a car or a truck), a watercraft (e.g., a ship or a boat) and/or an aircraft. For example, the transportation service may be a taxi service or a delivery service.

Second request obtaining unit 320 may be configured to obtain one or more transaction requests requesting one or more transportation services from one or more service receivers. The service provider and/or the service receiver may use a device to communicate with processing engine 112 through network 120. The device may include a desktop, an All-in-One personal computer (AIO), a notebook, a smartphone, a Personal Digital Assistant (FDA), a tablet, a carputer, a handheld game player, a wearable device (e.g., smart glasses or smartwatch), a virtual display device (e.g., Oculus Rift or Gear VR), a augmented display device (e.g., Google Glass, Hololens), or the like, or any combination thereof.

Assignment strategy generation unit 330 may be configured to generate an assignment strategy. In some embodiments, the assignment strategy may include a first strategy and/or a second strategy. The first strategy may include combining two or more transportation services into a new transportation service. Under the second strategy, the two or more transportation services may not be combined into a new transportation service.

Assignment unit 340 may be configured to send the assignment strategy to the service provider and/or the one or more service receivers.

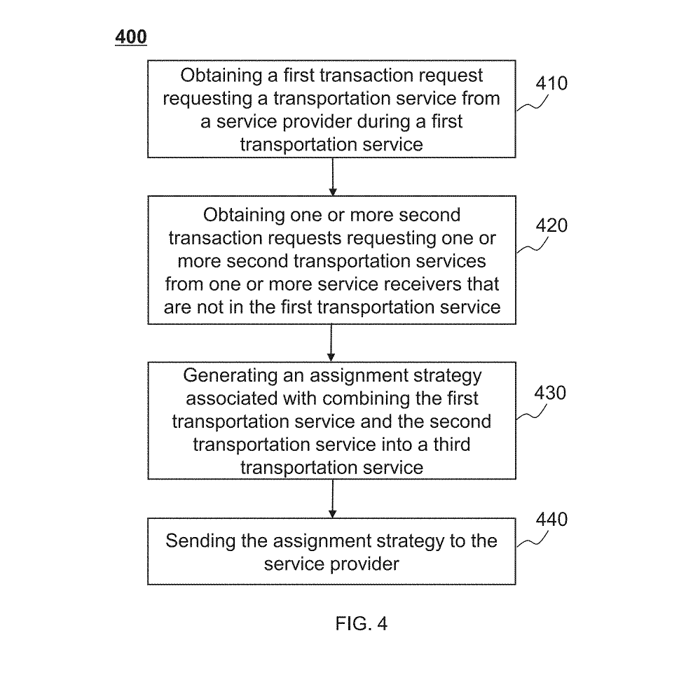

FIG. 4 is a flowchart illustrating an exemplary process of a carpool service according to some embodiments of the present disclosure. Process 400 may be implemented as an application or a set of instructions stored in a non-transitory storage medium of a computer, such as the computer server 110 in the system 100.

The carpool service refers to an arrangement that combines two or more transportation services into a new transportation service. The present disclosure takes combining two transportation services into a new transportation service as an example of a carpool service. It should be noted that the carpool service of combining two transportation services into a new transportation service is merely provided for the purposes of illustration, and not intended to limit the scope of the present disclosure. For example, some embodiments, this disclosure may be applied to a carpool service of combining more than two transportation services into a new transportation service.

In step 410, first request obtaining unit 310 may obtain a first transaction request requesting a transportation service from a service provider during a first transportation service.

In some embodiments, before the service provider transmits the first transaction request, the first transportation service may include a first sub transportation service and a second sub transportation service. For example, the first transportation service may be a taxi carpool service for two passengers. For example, the first sub transportation service may be a taxi service for John; and the second sub transportation service may be a taxi service for Carl. The first transportation service may also be a carpool service between a passenger and goods or between goods. For example, the first transportation service may be a carpool service between passenger John and a furniture. In some embodiments, the service provider may transmit the first transaction request to processing engine 112 when the service provider completes or about to complete the first sub transportation service or the second sub transportation service. In some embodiments, the first transaction request may include a location of the service provider at a time point, a destination of the first transportation service (e.g., a drop-off location of the taxi service for John), or the like, or any combination thereof. In some embodiments, the destination of the first transportation service may be the destination of the first sub transportation service or the destination of the second sub transportation service, whichever travels farther. For example, if the service provider transmitted the first transaction request to processing engine 112 when the service provider completes or about to complete the first sub transportation service, the destination of the first transportation service may be the destination of the second sub transportation service; if the service provider transmitted the first transaction request to processing engine 112 when the service provider completes the second sub transportation service, the destination of the first transportation service may be the destination of the first sub transportation service. The time point may be a time point when the service provider transmitted the first transaction request to processing engine 112.

In some embodiments, the first transportation service may correspond to a first route. The first route may be determined by assignment strategy generation unit 330 according to the location of the service provider at the time point and the destination of the first transportation service.

In step 420, second request obtaining unit 320 may obtain one or more second transaction requests. The second transaction request may be a transaction request from a service receiver, requesting a second transportation service that is not in the first transportation service. For example, second request obtaining unit 320 may obtain second transaction request X, second transaction request Y, second transaction request W and second transaction request Z. Second transaction request X may be a transaction request from service receiver X′, requesting second transportation service X (e.g., a taxi service from location X₁ to location X₂). Second transaction request Y may be a transaction request from service receiver Y′, requesting second transportation service Y (e.g., an item delivery service from location Y₁ to location Y₂). Second transaction request W may be a transaction request from service receiver W, requesting second transportation service W (e.g., a taxi service from location W₁ to location W₂). Second transaction request Z may be a transaction request from service receiver Z′, requesting second transportation service Z (e.g., a taxi service from location Z₁ to location Z₂). As another example, second request obtaining unit 320 may obtain one second transaction request. In some embodiments, the second transaction request may be a transaction request that has not been accepted by any service provider.

The second transaction request may include a real-time transaction request or an appointment transaction request. As used herein, a real-time transaction request may be a transaction request that the requestor wishes to conduct the requested transaction (e.g., transportation service) at the present moment or at a defined time reasonably close to the present moment for an ordinary person in the art. For example, a transaction request may be a real-time transaction request if the defined time is shorter than a threshold value, such as 1 minute, 5 minutes, 10 minutes or 20 minutes. The appointment transaction request may refer to that the requestor wishes to conduct the requested transaction at a defined time which is reasonably far from the present moment for the ordinary person in the art. For example, a transaction request may be an appointment transaction request if the defined time is longer than a threshold value, such as 20 minutes, 2 hours, or 1 day. In some embodiments, processing engine 112 may define the real-time transaction request or the appointment transaction request based on a time threshold. The time threshold may be default settings of on-demand service system 100, or may be adjustable depending on different situations. For example, in a traffic peak period, the time threshold may be relatively small (e.g., 10 minutes), otherwise in idle period (e.g., 10:00-12:00 am), the time threshold may be relatively large (e.g., 1 hour).

In some embodiments, the second transaction request may include a request time of the second transaction request, information of whether the service receiver agrees to combine the second transportation service and the first transportation service into a third transportation service, an origin of the second transportation service (e.g., a pickup location of a taxi service), a destination of the second transportation service, or the like, or any combination thereof. In some embodiments, the origin of the second transportation service and/or the destination of the second transportation service may be determined by the service receiver. In some embodiments, if the second transaction request includes the information of whether the service receiver agrees to combine the second transportation service and the first transportation service, second request obtaining unit 320 may obtain the second transaction request of which the information is to agree to combine the second transportation service and the first transportation service. However, if the transaction request does not include the information of whether the service receiver agrees to combine the second transportation service with the first transportation service, after obtaining the transaction request, processing engine 112 may send a message to the service receiver to determine whether the service receiver agrees to combine the second transportation service with the first transportation service. Alternatively, processing engine 112 may determine that the default condition for the second transaction request is that the requester agrees to combine the second transportation service with the first transportation service, or the processing engine 112 may determine that the default condition for the second transaction request is that the requester refuses to combine the second transportation service with any other transportation service.

In some embodiments, the second transportation service may correspond to a second route. The second route may be determined by assignment strategy generation unit 330 according to the origin of the second transportation service and the destination of the second transportation service.

In some embodiments, second request obtaining unit 320 may obtain the second transaction request of which the origin is in a certain area according to the first transaction request. For example, the distance between the origin of the second transaction request and the location of the service provider at the time point may be less than a first threshold (e.g., 3 kilometer). As another example, if the location of the service provider at the time point is in, for example, Manhattan, New York City, second request obtaining unit 320 may obtain the second transaction request of which the origin is in Manhattan. In some embodiments, if there is no transaction request in the certain area, second request obtaining unit 320 may obtain a second transaction request in another area. Alternatively, second request obtaining unit 320 may obtain a second transaction request in the certain area after a period of time (e.g., after 1 minute).

In step 430, assignment strategy generation unit 330 may generate an assignment strategy.

In some embodiments, the assignment strategy may include a first strategy or a second strategy. The first strategy may include combining the first transportation service and a second transportation service into a third transportation service. Under the second strategy, the first transportation service and a second transportation service may not be combined into the third transportation service. The first strategy may include the origin of the second transportation service which is used to combine with the first transportation service, the destination of the second transportation service which is used to combine with the first transportation service, service receiver information of the service receiver of the second transportation service which is used to combine with the first transportation service, service provider information, or the like, or any combination thereof. The service receiver information may include receiver contact information (e.g., a phone number or an email address), object information (e.g., the number of passengers or the volume of goods), or the like, or any combination thereof. The service provider information may include provider contact information (e.g., a phone number or an email address), the name of the service provider, the plate number of the service provider, a location of the service provider, the capacity of the service provider (e.g., the passenger capacity or the goods capacity), or the like, or any combination thereof. The second strategy may include a strategy of assigning a second transaction request to a service provider associated with a fourth transportation service. Alternatively or additionally, the second strategy may include a strategy of assigning a second transaction request to an idle service provider, i.e., a service provider that is not serving anyone.

In some embodiments, the third transportation service may correspond to a third route. The third route may be determined by assignment strategy generation unit 330 according to the first transportation service and a second transportation service. Further, the third route may be determined according to the first route and the second route corresponding to the second transportation service. In some embodiments, the service provider may pick up the service receiver from the origin of the second transportation service and drop the service receiver from the destination of the second transportation service. As a result, the third route may be determined according to the location of the service provider at the time point, the destination of the first transportation service, the origin of the second transportation service and the destination of the second transportation service. In some embodiments, the third route may include a first sharing route corresponding to the first transportation service and a second sharing route corresponding to the second transportation service. In some embodiments, the third route may be sent to the service provider and/or the service receiver by assignment unit 340.

In step 440, assignment unit 340 may send the assignment strategy to the service provider. Additionally or alternatively, assignment unit 340 may send the assignment strategy to the service receiver.

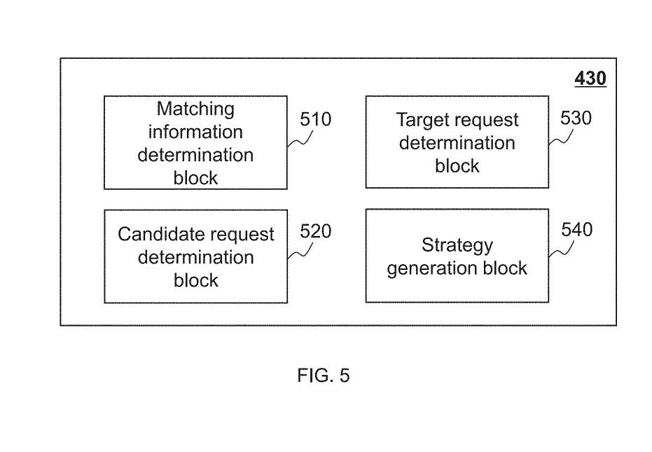

FIG. 5 is a block diagram illustrating an exemplary architecture of an assignment strategy generation unit 330 according to some embodiments of the present disclosure. As illustrated, assignment strategy generation unit 330 may include a matching information determination block 510, a candidate request determination block 520, a target request determination block 530 and a strategy generation block 540.

Matching information determination block 510 may be configured to determine matching information according to the first transaction request and the one or more second transaction requests. In some embodiments, the matching information may be used to determine whether the second transportation service of the second transaction request is suitable to be combined with the first transportation service. In some embodiments, if second request obtaining unit 320 obtains one second transaction requests, matching information determination block 510 may determine the matching information of the second transaction request. In some embodiments, if second request obtaining unit 320 obtains more than one second transaction requests, matching information determination block 510 may determine the matching information of each second transaction request, respectively. In some embodiments, the matching information may include a first ratio of the length of the first sharing route to the length of the first route, a second ratio of the length of the second sharing route to the length of the second route, or the like, or any combination thereof. Here, the first ratio or the second ratio may refer to a ratio between the length of a route corresponding to an individual transportation service (e.g., the first sub transportation service, the second sub transportation service or the second transportation service) and the length of a route corresponding to a combined transportation service (e.g., the third transportation service). In some embodiments, for the third transportation service, in order to satisfy both of the first transportation service and the second transportation service, the length of the first sharing route in the third route corresponding to the third transportation service may be longer than the first route, and the length of the second sharing route in the third route corresponding to the third transportation service may be longer than the second route. The first ratio may be defined as the extent of detour of the first transportation service, and the second ratio may be defined as the extent of detour of the second transportation service. In some embodiments, the extent of detour of the first transportation service and the extent of detour of the second transportation service may be used to determine whether the second transportation service is suitable to be combined with the first transportation service.

Candidate request determination block 520 may be configured to determine one or more candidate transaction requests according to the matching information. In some embodiments, the candidate transaction request may be a second transaction request of which the second transportation service is suitable to be combined with the first transportation service. In some embodiments, if second request obtaining unit 320 obtains one second transaction request, candidate request determination block 520 may determine whether the second transportation service corresponding to the second transaction request is suitable to be combined with the first transportation service (i.e., candidate request determination block 520 may determine whether the second transaction request is a candidate transaction request). In some embodiments, if second request obtaining unit 320 obtains more than one second transaction requests (e.g., second transaction request X, second transaction request Y, second transaction request W and second transaction request Z), candidate request determination block 520 may select one or more candidate transaction requests from the more than one second transaction requests.

Target request determination block 530 may be configured to determine a target transaction request according to the one or more candidate transaction requests. In some embodiments, the target transaction request may be a second transaction request requesting a second transportation service that is used to combine with the first transportation service. In some embodiments, if candidate request determination block 520 determines more than one candidate transaction requests, target request determination block 530 may select one candidate transaction request, from the more than one candidate transaction requests, as the target transaction request.

Strategy generation block 540 may be configured to generate an assignment strategy according to the target transaction request.

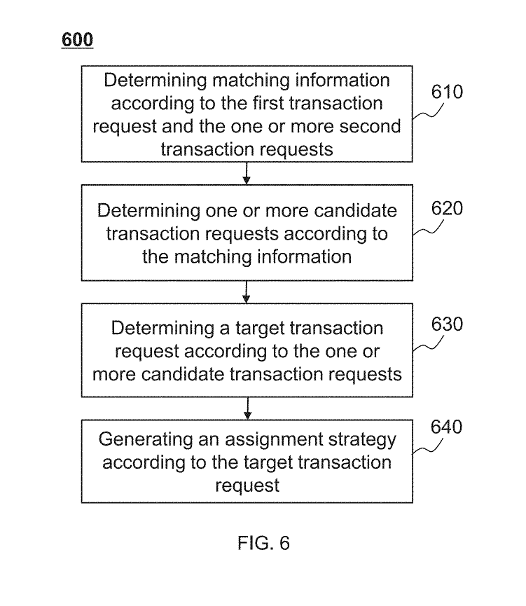

FIG. 6 is a flowchart illustrating an exemplary process of generating an assignment strategy according to some embodiments of the present disclosure. In some embodiments, process 600 may be used to generate the assignment strategy in step 430 of process 400. Process 600 may be implemented as an application or a set of instructions stored in a non-transitory storage medium of a computer, such as the computer server 110 in the system 100.

In step 610, matching information determination block 510 may determine matching information according to the first transaction request and the one or more second transaction requests. In some embodiments, the matching information may include a first ratio of the length of the first sharing route to the length of the first route, a second ratio of the length of the second sharing route to the length of the second route, or the like, or any combination thereof. In some embodiments, the matching information may be determined according to the location of the service provider at the time point, the destination of the first transportation service, the origin of the second transportation service and/or the destination of the second transportation service.

In step 620, candidate request determination block 520 may determine one or more candidate transaction requests according to the matching information. In some embodiments, if second request obtaining unit 320 obtains one second transaction request, candidate request determination block 520 may determine whether the second transportation service corresponding to the second transaction request is suitable to be combined with the first transportation service (i.e., candidate request determination block 520 may determine whether the second transaction request is a candidate transaction request). In some embodiments, if second request obtaining unit 320 obtains more than one second transaction requests (e.g., second transaction request X, second transaction request Y, second transaction request W and second transaction request Z), candidate request determination block 520 may determine one or more candidate transaction requests from the more than one second transaction requests.

In some embodiments, the second transaction request of which the matching information satisfies one or more conditions may be determined as a candidate transaction request by candidate request determination block 520. In some embodiments, if the matching information includes one factor, the second transaction request of which the factor in the matching information satisfies one or more conditions may be determined as a candidate transaction request by candidate request determination block 520. In some embodiments, if the matching information includes more than one factors, the second transaction request of which all of the factors in the matching information satisfy one or more conditions may be determined as a candidate transaction request by candidate request determination block 520. For example, if the matching information includes the first ratio, the second transaction request of which the first ratio is less than a third threshold may be determined as a candidate transaction request by candidate request determination block 520. As another example, if the matching information includes the first ratio and the second ratio, the second transaction request of which the first ratio is less than the third threshold and the second ratio is less than a fourth threshold may be determined as a candidate transaction request by candidate request determination block 520. In some embodiments, if there is no candidate transaction request, second request obtaining unit 320 may obtain some other second transaction request(s) after a period of time (e.g., after 1 minute). Alternatively, second request obtaining unit 320 may obtain some other second transaction request(s) in another area.

In step 630, target request determination block 630 may determine a target transaction request according to the one or more candidate transaction requests.

In some embodiments, if there are more than one candidate transaction requests, target request determination block 630 may determine the target transaction request by ranking the more than one candidate transaction requests according to the matching information. In some embodiments, if the matching information includes one factor, the more than one candidate transaction requests may be ranked according to the factor. In some embodiments, if the matching information includes more than one factors, target request determination block 630 may determine a score according to the factors, and the more than one candidate transaction requests may be ranked according to the score. For example, if the matching information includes the first ratio, the target transaction request may be the second transaction request of which the first ratio is the least. As another example, if the matching information includes the first ratio and the second ratio, a score may be determined according to the first ratio, a weight of the first ratio, the second ratio and a weight of the second ratio. The target transaction request may be the transaction request of which the score is the highest.

In some embodiments, if second request obtaining unit 320 obtains one second transaction request, step 630 may be omitted. In some embodiments, if the number of the candidate transaction requests is less than or equal to 1, step 630 may be omitted.

In step 640, strategy generation block 540 may generate an assignment strategy according to the target transaction request. In some embodiments, when second request obtaining unit 320 obtains one second transaction request, if candidate request determination block 520 determines that the second transportation service of the second transaction request is suitable to be combined with the first transportation service (i.e., candidate request determination block 520 may determine that the second transaction request is a candidate transaction request), strategy generation block 540 may generate the first strategy. If candidate request determination block 520 determines that the second transportation service of the second transaction request is not suitable to be combined with the first transportation service (i.e., candidate request determination block 520 may determine that the second transaction request is not a candidate transaction request), strategy generation block 540 may generate the second strategy. In some embodiments, if second request obtaining unit 320 obtains more than one second transaction requests, for the target transaction request, strategy generation block 540 may generate a first strategy. For the second transaction requests which are not determined as the target transaction request, strategy generation block 540 may generate a second strategy. For example, if second request obtaining unit 320 obtains second transaction request X, second transaction request Y, second transaction request W and second transaction request Z, and target request determination block 530 determines second transaction request Z as the target transaction request, strategy generation block 540 may generate the first strategy for second transaction request Z and generate the second strategy for second transaction request X, second transaction request Y and second transaction request Z.

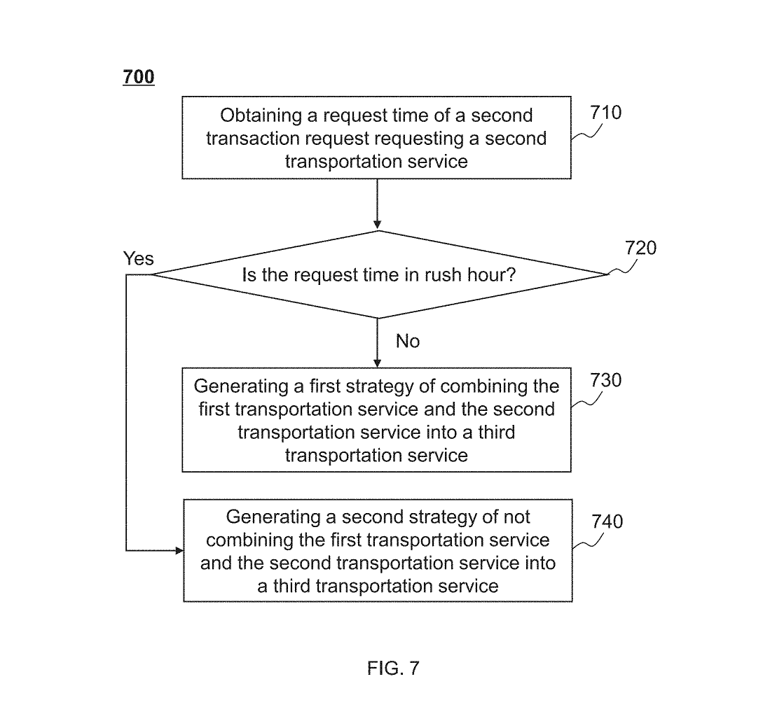

FIG. 7 is a flowchart illustrating an exemplary process of generating an assignment strategy according to some embodiments of the present disclosure. In some embodiments, process 700 may be used for generating the assignment strategy in step 430 of process 400. Process 700 may be implemented as an application or a set of instructions stored in a non-transitory storage medium of a computer, such as the computer server 110 in the system 100.

In some embodiments, a carpool service may be inefficient in rush hour. So a request time of a second transaction request may be considered when generating an assignment strategy.

In some embodiments, if second request obtaining unit 320 obtains one second transaction request, process 700 may be used to generate an assignment strategy for the second transaction request. If second request obtaining unit 320 obtains more than one second transaction requests, process 700 may be used to generate an assignment strategy for one of the more than one second transaction requests. The process of generating an assignment strategy for other second transaction requests may be same as process 700.

In step 710, assignment strategy generation unit 330 may obtain a request time of a second transaction request requesting a second transportation service from a service receiver. In some embodiments, the request time may be the time point when the service receiver transmits the second transaction request to processing engine 112.

In step 720, assignment strategy generation unit 330 may determine whether the request time is in rush hour. If the answer is “yes”, that is, the request time is in rush hour, the process may proceed to step 740 to generate the second strategy of not combining the first transportation service and the second transportation service into the third transportation service by assignment strategy generation unit 330. If the answer is “no”, that is, the request time is not in rush hour, the process may proceed to step 730 to generate the first strategy of combining the first transportation service and the second transportation service into the third transportation service by assignment strategy generation unit 330. Here, the rush hour may refer to one of the periods of the day when there is heavy traffic. For example, the rush hour may include one of the periods of the day when most people are travelling to or from work, or when there is an event (e.g., a music concert or a traffic accident). In some embodiments, the rush hour may be a numerical range. In some embodiments, if the answer is “yes”, assignment unit 340 may send a message of refusing the transaction request to the service receiver.

In some embodiments, process 700 may be performed before step 610, step 620, step 630 or step 640 in process 600, and if the answer of step 720 is “no”, the process may proceed to step 610, step 620, step 630 or step 640 in process 600. For example, when process 700 is performed before step 610, if the answer of step 720 is “no”, process 700 may proceed to step 610 to determine the matching information.

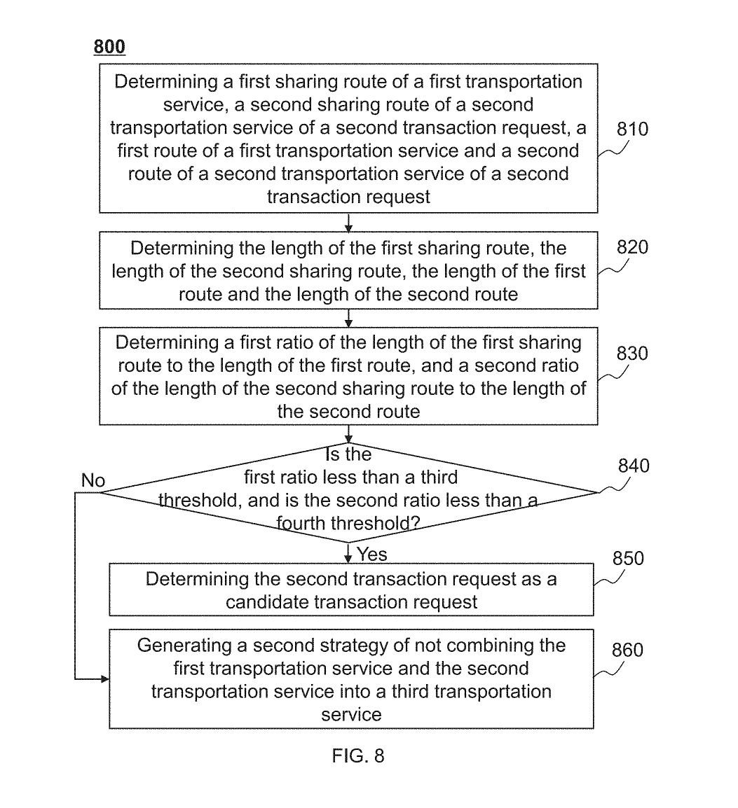

FIG. 8 is a flowchart illustrating an exemplary process of determining one or more candidate transaction requests according to some embodiments of the present disclosure. Process 800 may be implemented as an application or a set of instructions stored in a non-transitory storage medium of a computer, such as the computer server 110 in the system 100.

In some embodiments, for the third transportation service, in order to satisfy both of the first transportation service and the second transportation service, the length of the first sharing route in the third route corresponding to the third transportation service may be longer than the first route, and the length of the second sharing route in the third route corresponding to the third transportation service may be longer than the second route. The first ratio of the length of first sharing route to the length of the first route may be defined as the extent of detour of the first transportation service, and the second ratio of the length of the second sharing route to the length of the second route may be defined as the extent of detour of the second transportation service. In process 800, candidate request determination block 520 may determine one or more candidate transaction requests according to the extent of detour of the first transportation service and the extent of detour of the second transportation service.

In some embodiments, if second request obtaining unit 320 obtains one second transaction request, process 800 may be used to determine whether the second transportation service of the second transaction request is suitable to be combined with the first transportation. If second request obtaining unit 320 obtains more than one second transaction requests, process 800 may be used to determine whether one of the more than one second transaction requests is a candidate transaction request. The process of determining whether the other second transaction requests are candidate transaction requests may be same as process 800.

In step 810, matching information determination block 510 may determine a first sharing route, a second sharing route, a first route and a second route. In some embodiments, the third route corresponding to the third transportation service may include the first sharing route and the second sharing route. The first sharing route may correspond to the first transportation service, and the second sharing route may correspond to a second transportation service of a second transaction request. The first sharing route may be a route from the location of the service provider at the time point to the destination of the first transportation service. The second sharing route may be a route from the origin of the second transportation service to the destination of the second transportation service.

In step 820, matching information determination block 510 may determine the length of the first sharing route, the length of the second sharing route, the length of the first route and the length of the second route.

In step 830, matching information determination block 510 may determine a first ratio of the length of the first sharing route to the length of the first route, and a second ratio of the length of the second sharing route to the length of the second route.

In step 840, candidate request determination block 520 may determine whether the first ratio is less than the third threshold, and whether the second ratio is less than the fourth threshold. If the answer is “yes”, that is, the first ratio is less than the third threshold, and the second ratio is less than the fourth threshold, the process may proceed to step 850 to determine the second transaction request as a candidate transaction request by candidate request determination block 520. If the answer is “no”, that is, the first ratio is larger than or equal to the third threshold, or the second ratio is larger than or equal to the fourth threshold, the process may proceed to step 860 to generate the second strategy of not combining the first transportation service and the second transportation service into a third transportation service by strategy generation block 540.

In some embodiments, steps 810-830 may be used for generating the matching information in step 610 of process 600. Steps 840-850 may be used to determine the one or more candidate transaction requests in step 620 of process 600.

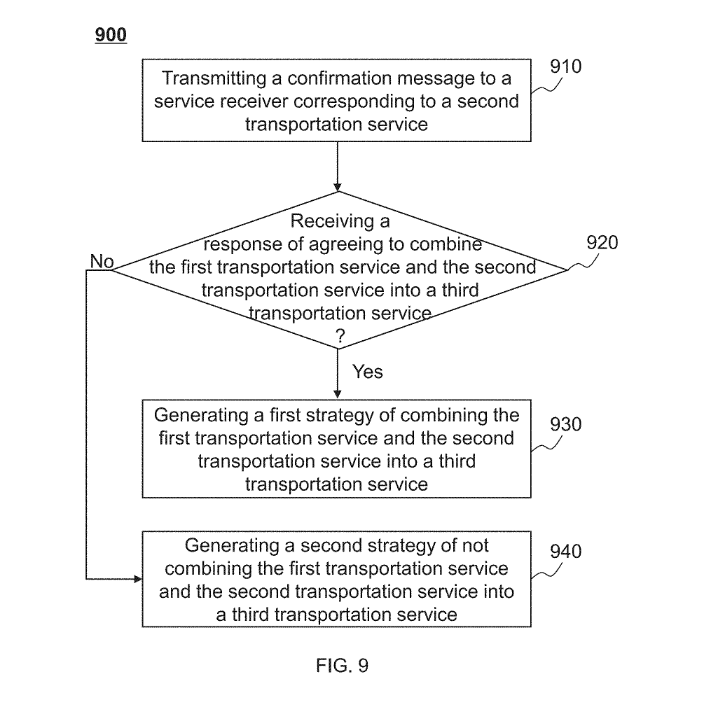

FIG. 9 is a flowchart illustrating an exemplary process of generating an assignment strategy according to some embodiments of the present disclosure. Process 900 may be used for generating the assignment strategy in step 430 of process 400. Process 900 may be implemented as an application or a set of instructions stored in a non-transitory storage medium of a computer, such as the computer server 110 in the system 100.

In some embodiments, if second request obtaining unit 320 obtains one second transaction request, process 900 may be used to generate an assignment strategy for the second transaction request. If second request obtaining unit 320 obtains more than one second transaction requests, process 900 may be used to generate an assignment strategy for one of the more than one second transaction requests. The process of generating an assignment strategy for other second transaction requests may be same as process 900.

In step 910, assignment strategy generation unit 330 may transmit a confirmation message to a service receiver corresponding to a second transportation service. In some embodiments, the confirmation message may be a message of determining whether the service receiver agrees to combine the first transportation service and the second transportation service into the third transportation service.

In step 920, assignment strategy generation unit 330 may determine whether it receives a response of agreeing to combine the first transportation service and the second transportation service into the third transportation service. If the answer is “yes”, that is, assignment strategy generation unit 330 receives the response, the process may proceed to step 930 to generate the first strategy of combining the first transportation service and the second transportation service into the third transportation service by assignment strategy generation unit 330. If the answer is “no”, that is, assignment strategy generation unit 330 does not receive the response, or assignment strategy generation unit 330 receives a response of refusing to combine the first transportation service and the second transportation service into the third transportation service, the process may proceed to step 940 to generate the second strategy of not combining the first transportation service and the second transportation service into the third transportation service by assignment strategy generation unit 330. In some embodiments, if assignment strategy generation unit 330 does not receive the response in a defined time (e.g., 1 minute, 5 minutes or 10 minutes), assignment strategy generation unit 330 may determine that it does not receive the response. The defined time may be default settings of on-demand service system 100, or may be adjustable depending on different situations. For example, in a traffic peak period (e.g., 7:00-10:00 am), the defined time may be relatively short (e.g., 1 minute), otherwise in idle period (e.g., 10:00-12:00 am), the defined time may be relatively long (e.g., 10 minutes).

In some embodiments, process 900 may be performed before step 610, step 620, step 630 or step 640 in process 600, and if the answer of step 920 is “yes”, the process may proceed to step 610, step 620, step 630 or step 640 in process 600. For example, when process 900 is performed before step 610, if the answer of step 920 is “yes”, process 900 may proceed to step 610 to determine the matching information.

In some embodiments, if the second transaction request include the information of whether to agree to combine the first transportation service and the second transportation service into the third transportation service, process 900 may be omitted.

In some embodiments, the first route may correspond to the first transportation service, the second route may correspond to the second transportation service, and the third route may correspond to the third transportation service. If there are more than one routes corresponding to the first transportation service, the second transportation service or the third transportation service, assignment strategy generation unit 330 may select one route that satisfies a condition. The condition may include that the length of the route is the shortest, the traveling time of the route is the least, the traffic lights in the route are least, or the like, or any combination thereof.

In some embodiments, the thresholds (e.g., the third threshold, the fourth threshold, or the like) mentioned in this disclosure may be obtained based on historical data, default settings of processing engine 112, or an instruction from a user.

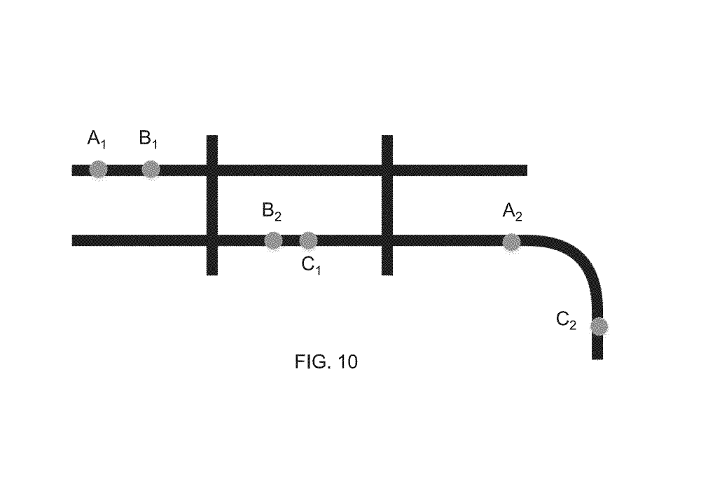

FIG. 10 is a diagram illustrating an exemplary process of a carpool service according to some embodiments of the present disclosure. As illustrated, A₁ refers to the origin of transaction request A of service receiver A, A₂ refers to the destination of transaction request A of service receiver A, B₁ refers to the origin of transaction request B of service receiver B, B₂ refers to the destination of transaction request B of service receiver B, C₁ refers to the origin of transaction request C of service receiver C, and C₂ refers to the destination of transaction request C of service receiver C. A service provider may provide transportation service S₁ to service receiver A and service receiver B, and transportation service S₁ may include transportation service A corresponding to transaction request A and transportation service B corresponding to transaction request B. When the service provider completes transportation service B, the service provider may send a transaction request to processing engine 112. Processing engine 112 may assign transaction request C of service receiver C to the service provider. The service provider may pick up service receiver C from C₁. Then, the service provider may provide transportation service S₂ to service receiver A and service receiver C, and transportation service S₂ may include transportation service A and transportation service C corresponding to transaction request C. The service provider may drop service receiver A from A₂ and drop service receiver C from C₁.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system configured to operating an online transportation service platform, comprising:
a bus;
one or more storage media electronically connected to the bus, comprising a set of instructions for operating an online carpool transportation platform; and
logic circuits configured to communicate with the one or more storage media via the bus, wherein when executing the set of instructions, the logic circuits are directed to:
obtain first electronic signals including a first transaction request associated with a transportation service from a service provider during a first transportation service, wherein the first transportation service includes a first sub transportation service and a second sub transportation service, and the first transaction request of the service provider is transmitted when the service provider completes the first sub transportation service or the second sub transportation service;
obtain second electronic signals including one or more second transaction requests, wherein the second transaction request is associated with a second transportation service from a service receiver that is not in the first transportation service, and the second transaction request requires the service provider to pick up the service receiver from a first location determined by the service receiver;
generate an assignment strategy associated with combining the first transportation service and the second transportation service into a third transportation service; and
send third electronic signals including the assignment strategy to the service provider.

2. The system of claim 1, wherein the first transportation service is associated with a first route;
the second transportation service is associated with a second route;
wherein the logic circuits are further directed to:
determine a third route for the third transportation service according to the first transportation service and the second transportation service; and
send fourth electronic signals including the third route to the service provider.

3. The system of claim 2, wherein to generate the assignment strategy the logic circuits are further directed to:
determine matching information according to the first transaction request and the second transaction requests;
determine one or more candidate transaction requests according to the matching information;
determine a target transaction request according to the candidate transaction requests; and
generate the assignment strategy according to the target transaction request.

4. The system of claim 3, wherein the third route includes a first sharing route associated with the first transportation service and a second sharing route associated with the second transportation service.

5. The system of claim 4, wherein to determine the matching information the logic circuits are further directed to:
determine a length of the first route, a length of the second route, a length of the first sharing route and a length of the second sharing route; and
determine a first ratio of the length of the first sharing route to the length of the first route, and a second ratio of the length of the second sharing route to the length of the second route.

6. The system of claim 1, wherein to generate the assignment strategy the logic circuits are further directed to:
obtain a request time of the second transaction request;
determine that the request time is in rush hour; and
determine that the assignment strategy is not to combine the first transportation service and the second transportation service into the third transportation service.

7. The system of claim 1, wherein to generate the assignment strategy the logic circuits are further directed to:
transmit fifth electronic signals including a confirmation message to the service receiver;
receive sixth electronic signals including a response of refusing to combine the first transportation service and the second transportation service into the third transportation service from the service receiver; and
determine that the assignment strategy is not to combine the first transportation service and the second transportation service into the third transportation service.

8. A method configured to operating an online transportation service platform, comprising:
obtaining, by a computer server of an online on-demand transportation service platform, first electronic signals including a first transaction request associated with a transportation service from a service provider during a first transportation service, wherein the first transportation service includes a first sub transportation service and a second sub transportation service, and the first transaction request of the service provider is transmitted when the service provider completes the first sub transportation service or the second sub transportation service;
obtaining, by the computer server, second electronic signals including one or more second transaction requests, wherein the second transaction request is associated with a second transportation service from a service receiver that is not in the first transportation service, and the second transaction request requires the service provider to pick up the service receiver from a first location determined by the service receiver;
generating, by the computer server, an assignment strategy associated with combining the first transportation service and the second transportation service into a third transportation service; and
sending, by the computer server, third electronic signals including the assignment strategy to the service provider.

9. The method of claim 8, wherein the first transportation service is associated with a first route;
the second transportation service is associated with a second route; and
the method further includes:
determining a third route for the third transportation service according to the first transportation service and the second transportation service; and
sending fourth electronic signals including the third route to the service provider.

10. The method of claim 9, wherein the generating of the assignment strategy includes:
determining matching information according to the first transaction request and the second transaction requests;
determining one or more candidate transaction requests according to the matching information;
determining a target transaction request according to the candidate transaction requests; and
generating the assignment strategy according to the target transaction request.

11. The method of claim 10, wherein the third route includes a first sharing route associated with the first transportation service and a second sharing route associated with the second transportation service.

12. The method of claim 11, wherein the determining of the matching information includes:
determining a length of the first route, a length of the second route, a length of the first sharing route and a length of the second sharing route; and
determining a first ratio of the length of the first sharing route to the length of the first route, and a second ratio of the length of the second sharing route to the length of the second route.

13. The method of claim 8, wherein the generating of the assignment strategy includes:
obtaining a request time of the second transaction request;
determining that the request time is in rush hour; and
determining that the assignment strategy is not to combine the first transportation service and the second transportation service into the third transportation service.

14. The method of claim 8, wherein the generating of the assignment strategy includes:
transmitting fifth electronic signals including a confirmation message to the service receiver;
receiving sixth electronic signals including a response of refusing to combine the first transportation service and the second transportation service into the third transportation service from the service receiver; and
determining that the assignment strategy is not to combine the first transportation service and the second transportation service into the third transportation service.

15. A non-transitory computer readable medium, comprising at east one set of instructions configured to operating an online transportation service platform, wherein when executed by one or more processors of a computing device, the at least one set of instructions causes the computing device to perform a method, the method comprising:
obtaining first electronic signals including a first transaction request associated with a transportation service from a service provider during a first transportation service, wherein the first transportation service includes a first sub transportation service and a second sub transportation service, and the first transaction request of the service provider is transmitted when the service provider completes the first sub transportation service or the second sub transportation service;
obtaining second electronic signals including one or more second transaction requests, wherein the second transaction request is associated with a second transportation service from a service receiver that is not in the first transportation service, and the second transaction request requires the service provider to pick up the service receiver from a first location determined by the service receiver;
generating an assignment strategy associated with combining the first transportation service and the second transportation service into a third transportation service; and
sending third electronic signals including the assignment strategy to the service provider.

16. The non-transitory computer readable medium of claim 15, wherein the first transportation service is associated with a first route;
the second transportation service is associated with a second route; and
the method further includes:
determining a third route for the third transportation service according to the first transportation service and the second transportation service; and
sending fourth electronic signals including the third route to the service provider.

17. The non-transitory computer readable medium of claim 16, wherein the generating of the assignment strategy includes:
determining matching information according to the first transaction request and the second transaction requests;
determining one or more candidate transaction requests according to the matching information;
determining a target transaction request according to the candidate transaction requests; and
generating the assignment strategy according to the target transaction request.

18. The non-transitory computer readable medium of claim 17, wherein the third route includes a first sharing route associated with the first transportation service and a second sharing route associated with the second transportation service.

19. The non-transitory computer readable medium of claim 18, wherein the determining of the matching information includes:
determining a length of the first route, a length of the second route, a length of the first sharing route and a length of the second sharing route; and
determining a first ratio of the length of the first sharing route to the length of the first route, and a second ratio of the length of the second sharing route to the length of the second route.

20. The non-transitory computer readable medium of claim 15, wherein the generating of the assignment strategy includes:
obtaining a request time of the second transaction request;
determining that the request time is in rush hour; and
determining that the assignment strategy is not to combine the first transportation service and the second transportation service into the third transportation service.
